(19) United States
(12) Patent Application Publication
(10) Pub. No.: US 2015/0149545 A1
(43) Pub. Date: May 28, 2015

(54) APPARATUS AND METHOD FOR SHARING OF LOCATION INFORMATION USING SOCIAL NETWORK SERVICE

(71) Applicants: Hyundai Motor Company, Seoul (KR); Hyundai Motor America, Fountain Valley, CA (US)

(72) Inventors: Jungwoo KIM, Seoul (KR); Hyung Soon PARK, Seoul (KR); Evangeline LA, Costa Mesa, CA (US); Michael DEITZ, Costa Mesa, CA (US)

(73) Assignees: Hyundai Motor America; Hyundai Motor Company

(21) Appl. No.: 14/304,408

(22) Filed: Jun. 13, 2014

(30) Foreign Application Priority Data
Nov. 28, 2013 (KR) 10-2013-0146463

(51) Int. Cl. H04L 29/08

(52) U.S. Cl. CPC H04L 67/22; H04L 67/18
USPC 709/204

(57) ABSTRACT

An apparatus and a method for sharing of location information using a social network service are provided. The apparatus includes a communicator configured to communicate with a server for sharing of location information. A storage is configured to map and store at least one first account to a vehicle unique number, and map and store at least one second account of social network service to the first account. A controller is configured to confirm and display, when a login is completed using the first account, a point of interest (POI), and a current location of the vehicle through the server, and to share the current location and information through the social network service corresponding to the second account mapped to the first account.

### CROSS-REFERENCE TO RELATED APPLICATION

This application claims the benefit of priority to Korean Patent Application No. 10-2013-0146463, filed on Nov. 28, 2013 in the Korean Intellectual Property Office, the disclosure of which is incorporated herein in its entirety by reference.

### TECHNICAL FIELD

The present disclosure relates to an apparatus and a method for sharing of location information using a social network service (SNS), and more particularly, to an apparatus and a method for sharing of location information using a social network service that a user account registered in a vehicle identification number (VIN) is connected with another SNS account to share location information of a driver with each other.

### BACKGROUND

Recently, by conflating a mobile communication system, a satellite positioning technology, and a map information technology, a technology of providing a user through electronic devices such as a smart phone and the like, with various services has been developed. The various services include an automatic crash reporting service, an emergency service call, a road guidance service, a current location information sharing service of the user using a social network service, and the like.

In addition, users using the social network service have been increased dramatically in order to communicate in real time with other users throughout the world via the electronic devices, and the type of the social network service has also been increased continuously.

### SUMMARY

The present disclosure has been made in view of the above problems, and provides an apparatus and a method for sharing of location information using a social network service capable of managing a plurality of social network accounts using a user account corresponding to a vehicle identification number (VIN).

The present disclosure further provides an apparatus and a method for sharing of location information using a social network service capable of confirming current location information of those who are registered as a friend in the social network service of a vehicle and sending messages to the friend.

In accordance with an exemplary embodiment of the present disclosure, an apparatus for sharing of location information using a social network service is provided. The apparatus includes a communicator configured to communicate with a server for sharing of the location information. A storage is configured to map and store at least one first account to a vehicle unique number, and map and store at least one second account of social network service to the first account. A controller is configured to confirm and display, when a login is completed using the first account, a point of interest (POI) and a current location of the vehicle through the server for sharing of location information, and to share the current location and the location information through the social network service corresponding to the second account mapped to the first account.

The apparatus further includes a sensor configured to confirm the current location of the vehicle.

When a destination is input from an external, the controller searches the POI based on the destination through the server for sharing of the location information, and shares the location and information of the destination through the social network service.

When a signal to confirm the location of users registered in the second account is received from the external, the controller confirms a list and location of the users who are located within a certain distance based on the current location.

The controller sends a personal message to other users by using at least one of the accounts of the other users registered in the second account, a portable terminal phone number and an e-mail of the other users stored in a phone book.

The vehicle unique number is a vehicle identification number (VIN).

The communicator receives the at least one first account mapped to the vehicle unique number stored in the server for sharing of the location information and the at least one second account of the social network service mapped to the first account.

In accordance with another exemplary embodiment of the present disclosure, a method for sharing of location information using a social network service is provided. The method includes entering, by a controller, into a location information sharing mode based on an input from an external. It is confirmed by the controller that a login is completed for at least one first account mapped to a vehicle unique number. A point of interest (POI) and a current location of a vehicle are confirmed and displayed by the controller. The current location and the location information are shared through a social network service corresponding to at least one second account mapped to the first account by the controller. Before confirming that the login is completed, the method further includes entering into a location information sharing setting mode by the controller to map and store the first account and the second account.

Before confirming and displaying the POI and the current location of the vehicle, the method further includes a step of entering into any one among a current location sharing mode of the vehicle, a destination searching mode, or a user location confirming mode based on the input from the external.

After the step of entering into the current location sharing mode of the vehicle, the method further includes confirming the current location of the vehicle in the current location sharing mode of the vehicle by the controller. The POI is confirmed according to the current location. Detailed information is displayed, which is related to the selected POI when the POI is selected. A call is connected to the POI corresponding to the selected information when the displayed detailed information is selected.

After the step of entering into the destination searching mode of the vehicle, the method further includes searching a destination of the vehicle in the destination searching mode of the vehicle. the POI is confirmed according to the destination. Detailed information is displayed, which is related to the selected POI when the POI is selected. A call is connected to the POI corresponding to the selected information when the displayed detailed information is selected.

After the step of entering into the user location confirming mode, the method further includes confirming a current location of users registered in the second account. A list of the users who are located within a certain distance is extracted and displayed based on the current location of the vehicle.

After the step of sharing the current location and information, the method further includes sending a personal message to other users using at least one of account of the other users registered in the second account, a portable terminal phone number and an e-mail of the other users stored in a phone book.

### BRIEF DESCRIPTION OF THE DRAWINGS

The objects, features, and advantages of the present disclosure will be more apparent from the following detailed description in conjunction with the accompanying drawings.

FIG. 1 is a diagram illustrating a main configuration of a system for sharing of location information according to an exemplary embodiment of the present disclosure.

FIG. 2 is a block diagram illustrating a main configuration of an apparatus for sharing of location information according to an exemplary embodiment of the present disclosure.

FIG. 3 is a flow chart for explaining a method of registering a plurality of accounts in one account corresponding to a vehicle identification number (VIN) according to an exemplary embodiment of the present disclosure.

FIG. 4 is a flow chart for explaining a method for sharing of location information using a social network service according to an exemplary embodiment of the present disclosure.

FIGS. 5A to 5F are exemplified diagrams illustrating a screen for sharing of location information according to an exemplary embodiment of the present disclosure.

### DETAILED DESCRIPTION

Exemplary embodiments of the present disclosure are described with reference to the accompanying drawings in detail. The same reference numerals are used throughout the drawings to refer to the same or like parts. Detailed descriptions of well-known functions and structures incorporated herein may be omitted to avoid obscuring the subject matter of the present disclosure.

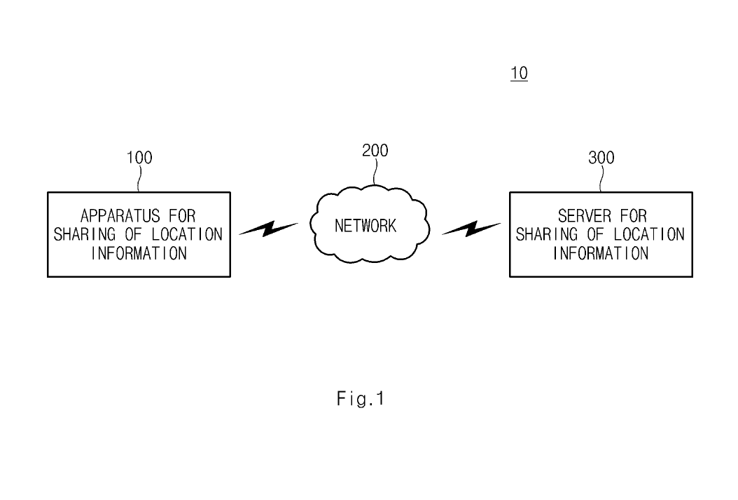

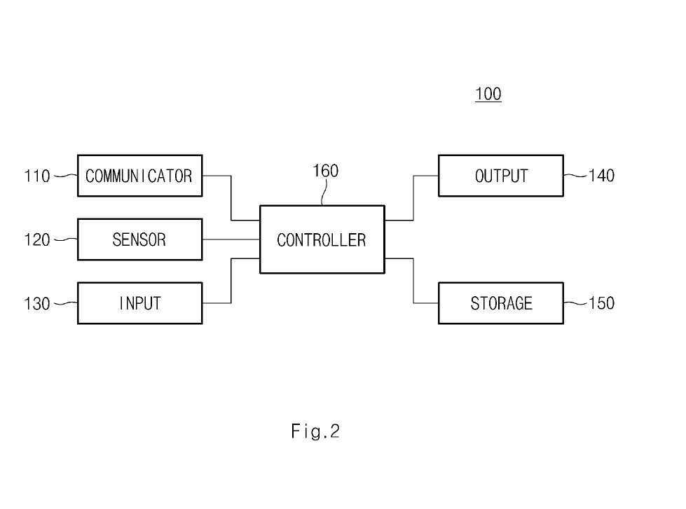

FIG. 1 is a diagram illustrating a main configuration of a system for sharing of location information according to an exemplary embodiment of the present disclosure. FIG. 2 is a block diagram illustrating a main configuration of an apparatus for sharing of location information according to an exemplary embodiment of the present disclosure.

Referring to FIGS. 1 and 2, a system 10 for sharing of location information according to an exemplary embodiment of the present disclosure may include an apparatus 100 for sharing of the location information, a network 200, and a server 300 for sharing of location information.

The apparatus 100 for sharing of location information communicates with the server 300 through the network 200, and downloads and installs applications for sharing of location information from the server 300. The application for sharing of location information receives a vehicle identification number from a user. The apparatus 100 f generates at least one first account by receiving an ID and password for the vehicle identification number, and receives at least one second account of social network services (facebook, twitter, foursquare, and the like) from the user to connect the second account to the first account. The at least one first account is generated for the vehicle identification number, such that another user who is a non-owner of the vehicle may use the location information service according to an exemplary embodiment of the present disclosure. The application provides a current location of the user, a destination, and a point of interest (POI) to the user, and may send a personal message to accounts of other users registered in the second account and phone numbers and e-mails of the other users registered in a phone book of an electronic device such as a portable terminal, a smart phone, or the like. The apparatus 100 is provided in the vehicle, so that the user may share the current location of the vehicle with the second account and confirm locations of the other users registered in the second account. To this end, the apparatus 100 may include a communicator 110, a sensor 120, an input 130, an output 140, a storage 150, and a controller 160.

The communicator 110 communicates with the server 300 by a wireless communication and is connected to the electronic device (not shown) by performing a short distance communication such as Bluetooth or the like to perform a phone call. The communicator 110 outputs a list of telephone numbers stored in the phone book of the electronic device on the output 140 through the short distance communication such as the Bluetooth with the electronic device.

The sensor 120 may include a global positioning system (GPS) sensor to confirm the location of the vehicle. The sensor 120 confirms the current location of the vehicle to provide the confirmed location to the controller 160.

The input 130 is formed by an input device such as a key pad, a touch pad, a touch screen, and the like, and generates an input signal based on the input received from a driver to provide the generated input signal to the controller 160. The input 130 may be installed in an audio, video, navigation (AVN) terminal and a center fascia provided in the vehicle.

The output 140 displays a screen for the current location of the vehicle, and outputs all processes for sharing of the location information such as a moving path to the destination, a location of a social network service user who is within a critical distance based on the current location of the vehicle, and the like. The output 140 may be formed by a touch screen, and in this case, the output 140 can serve as the input 130.

The storage 150 stores the application for sharing of the location information. The storage 150 stores map data received from the server 300 and stores a vehicle identification number (VIN) assigned to the vehicle and the ID and password corresponding to the at least one first account mapped to the VIN. In addition, the storage 150 maps and stores the second account configured of the ID and password for at least one social network service to the first account.

When a login is completed using the first account mapped to the vehicle identification number (VIN), the controller 160 logs in the social network service corresponding to the second account mapped to the first account. Here, when a large number of users use the one vehicle, since the first account may be set to a single VIN for each user, the controller 160 may impart a security key such as a PIN for each user. In this case, the users input the security key such as a granted PIN to log in the first account and the second account.

After the login is completed, the controller 160 receives the information on the current location of the vehicle from the GPS of the sensor 120, transmits the received information to the server 300 through the communicator 10, and receives the POI confirmed based on the current location from the server 300. The controller 160 controls the output 140 to output the map data stored in the storage 150, and displays the current location of the vehicle and the POI based on the current location.

In addition, when the destination is input from the input 130, the controller 160 outputs the moving path from the current location of the vehicle to the destination on the output 140 and receives the POI confirmed based on the destination from the server 300 to output the POI on the output 140.

When the signal to confirm the location of other user registered in the second account is input from the input 130, the controller 160 receives a list of the users who are within a certain distance based on the current location of the vehicle. The controller 160 controls the output 140 to output the current location of the vehicle and the location of the other user on the map data, and receives the POI confirmed based on the current location of the vehicle from the server 300 to output the POI on the output 140.

When a selection signal for any one of the POIs which are output on the output 140 is input from the input 130, the controller 160 outputs detailed information related to the selected POI. Here, the detailed information may be information including an accurate location of the POI, and a type of business, telephone number and name of the business office located at the POI. Then, when the selection signal for a specific POI is received from the input 130, the controller 160 connects a phone call to the phone number corresponding to the specific POI.

When the signal for sharing of the current location of the vehicle is input through the social network service corresponding to the second account from the input 130, the controller 160 uploads the current location to share the current location with the users registered in the second account. In addition, when the destination is input from the input 130, the controller 160 outputs the moving path from the current location to the destination on the output 140 and confirms the current location of the vehicle to share the current location of the vehicle through the social network service. Here, an alarm message is input from the input 130, the controller 160 shares the alarm message together with the current location through the social network service. In addition, a selection signal for any one of the alarm messages stored in the storage 150 is input, the controller 160 shares the selected alarm message together with the current location through the social network service.

When a specific user is selected by the input 130, the controller 160 sends a personal message to the selected user. In this case, the specific user may be selected among the other users registered in the second account or may be a user for a telephone number which is selected among telephone numbers stored in the phone book of the electronic device of the user. In addition, the personal message sent to the specific user may be a message service provided by the social network service, a short message service (SMS) of a portable terminal, an e-mail, or the like. In this case, the alarm message may be included in the personal message. As described above, when the user attempts to confirm the location information of the other users, first, the login to the first account should be performed. Therefore, the security for receiving and sharing of location information is ensured.

The network 200 provides a wireless communication between the apparatus 100 and server 300.

The server 300 provides the application to the apparatus 100 so that the apparatus 100 may download and install the application. The server 300 stores various information such as the vehicle identification number, the at least one first account mapped to the vehicle identification number, and at least one second account mapped to the first account which are received from the apparatus 100 for sharing of location information. The server 300 provides the map data to the apparatus 100, so that the server 300 may search for the POI based on the current location of the vehicle and destination. In addition, the server 300 may provide the social network service, so that the user may use the social network service.

In addition, for convenience of explanation, it is illustrated that the server 300 provides the map data to the apparatus 100 for sharing of location information, but the present disclosure is not necessarily limited thereto. The system 10 for sharing of location information may include a separate map data providing server (not shown). In this case, when a search request for the POI is received from the apparatus 100 for sharing of location information, the map data providing server search the POI based on the current location of the vehicle or the destination and may provide the POI to the apparatus 100.

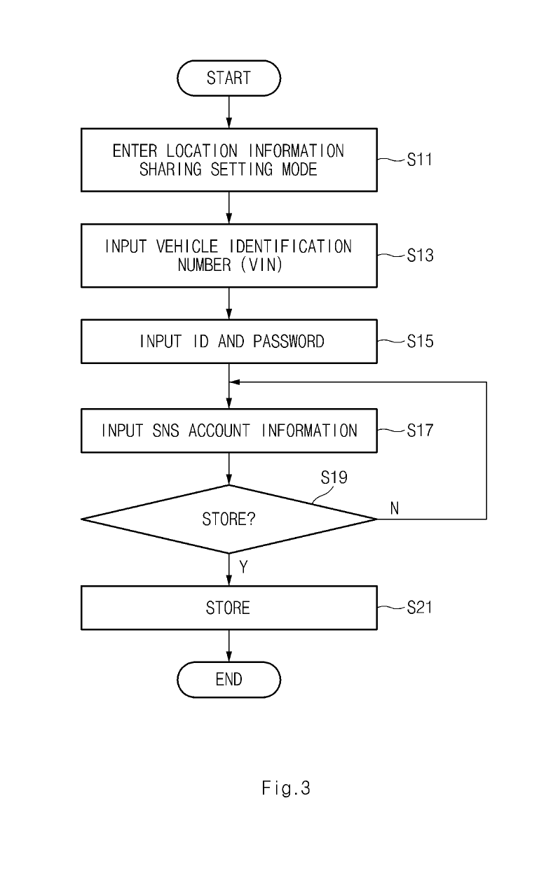

FIG. 3 is a flow chart for explaining a method of registering a plurality of accounts in one account corresponding to a vehicle identification number (VIN) according to an exemplary embodiment of the present disclosure.

Referring to FIG. 1 to FIG. 3, at step S11, the controller 160 enters into a location information sharing setting mode by an input received from the input 130. Here, the location information sharing setting mode may execute a menu selected from the input 130 after the controller 160 executes the application to share the location information stored in the storage 150 based on the input received from the input 130. At the time of executing the application, the controller 160 controls the communicator 110 to communicate with the server 300.

At step S13, the controller 160 stores the vehicle identification number (VIN) which is input from the input 130 into the storage 150, and transmits the VIN to the server 300. In this case, the VIN may be automatically stored in the storage 150 through a controller area network (CAN) communication.

At step S15, the controller 160 generates the first account corresponding to the VIN by inputting the ID and password corresponding to the VIN through the input 130 to authenticate the generated first account. Here, the ID and password may be directly set by the user and may be previously allocated according to the VIN. At this time, when a large number of users use the same vehicle, since the first account may be set for each user to single VIN, the controller 160 may impart a security key such as a PIN for each user.

When the first account generation and authentication are completed at step S15, the controller 160 receives the account information (hereinafter, referred to as second account) related to a plurality of social network services from the input 130 at step S17. The social network service may be various types of services such as twitter, foursquare, facebook, and the like.

Then, when the signal for storing is received from the input 130 at step S19, the controller 160 proceeds to step S21, and connects the first account and the second account to store in the storage 150. In addition, the controller 160 transmits the second account to the server 300 so that the second account may be connected with the first account and stored.

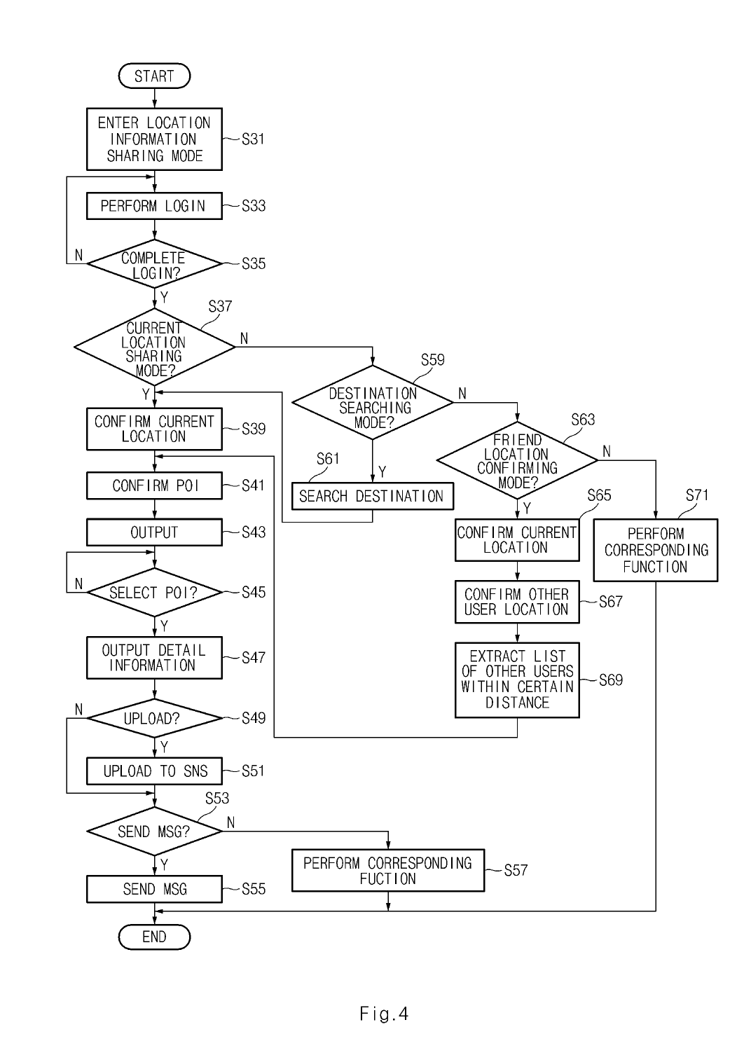

FIG. 4 is a flow chart for explaining a method for sharing of location information using a social network service according to an exemplary embodiment of the present disclosure.

Referring to FIG. 1 to FIG. 4, at step S31, the controller 160 enters into the location information sharing mode based on the signal received from the input 130. Here, the signal is recognized to execute the application for sharing the location information stored in the storage 150.

At step S33, the controller 160 receives the ID and password of the first account from the input 130 to login to the application. Here, when the security key such as the PIN that had granted to the user at step S15 of FIG. 3 is input, the controller 160 may log in through the input security key.

At step S35, the controller 160 determines whether the login is completed. As the determined results at step S35, when the login is completed, the controller 160 proceeds to step S37, and when the login is not completed, the controller 160 returns to step S33 to log in again. Here, when the authentication of the first account fails over threshold, the controller 160 deactivates the user authentication for a certain period of time, or may provide a security function such as a user re-authentication through a wire/wireless communication. In addition, when the user does not log out after the login completion, it is possible to execute the application by entering only the password at the time of executing the application, and when not using the application for a certain time after login, it is also possible to log out autonomously.

When the current location sharing mode is selected from the input 130 at step S37, the controller 160 proceeds to step S39, and when the current location sharing mode is not selected, the controller 160 proceeds to step S59.

When the current location sharing mode is selected at step S37, the controller 160 activates the GPS included in the sensor 120 to confirm the current location of the vehicle at step S39. In this case, the controller 160 may confirm the current location of the vehicle through cellular network. At step S41, the controller 160 confirms the POI based on the confirmed location of the vehicle. The controller 160 confirms the moving path of the driver and the map data previously stored in the storage 150 to thereby confirm the POI based on the current location. In addition, the controller 160 transmits the location information of the vehicle to the server 300 for sharing of location information, and may receive the POI from the server 300.

At step S43, the controller 160 displays the confirmed current location and the POI on the map data to output on the output 140. At step S45, when the selection signal for any one of the POIs displayed on the output 140 is received from the input 130, the controller 160 proceeds to step S47.

At step S47, the controller 160 outputs the detailed information related to the location corresponding to the selected POI. Here, the detailed information may include an accurate location of the POI, and a type of business, telephone number and name of the business office located at the POI.

When the signal to upload the current location is received from the input 130 at step S49, the controller 160 uploads the current location confirmed at step S39 to the social network service corresponding to the second account which is connected with the first account at step S51, and proceeds to step S53. At this time, when the message is input through the input 130, the controller 160 may upload the inputted alarm message together with the current location. When at least one alarm message is previously stored in the storage 150, the controller 160 outputs the pre-stored alarm message to the output 140, and calls the alarm message which is selected from the input 130 to upload the alarm message together with the current location.

As described above, the present disclosure provides the convenience of automatically logging in at least one social network service corresponding to the second account by logging in the first account.

After the current location of the vehicle is uploaded to the social network service, or when the signal for uploading the current location is not received from the input unit 130 at step S49, the controller 160 proceeds to step S53. When the signal for sending message is received from the input 130 at step S53, the controller 160 proceeds to step S55.

At step S55, the controller 160 sends the current location of the vehicle through a message. Here, the message means a personal message sent to a specific users selected among a plurality of users who are connected to the second account, a short message sent to the user selected from the user list stored in the phone book of the electronic device (not shown) of the user or an e-mail. In addition, the message may include the alarm message.

At step S55, when the signal for sending the message is not received from the input 130, the controller 160 proceeds to step S57 and performs the function corresponding to the inputted signal. In this case, the function corresponding to the inputted signal may be a function to perform the phone call with the business office located at the POI corresponding to the detailed information which is output at step S47 or to display a moving path from the current location to the POI.

When the current location sharing mode is not selected at step S37, the controller proceeds to step S59. If it is confirmed that a destination searching mode is selected from the input 130 at step S59, the controller 160 proceeds to step S61. If the destination searching mode is not selected from the input 130 at step S61, the controller 160 proceeds to step S63. At step S61, the controller 160 receives the destination from the input unit 130 and proceeds to step S39 to perform the above-mentioned steps.

At step S63, when a friend location confirming mode is selected from the input 130, the controller 160 proceeds to step S65. When the friend location confirming mode is not selected, the controller 160 proceeds to step S71. At step S65, the controller 160 activates the GPS to confirm the current location of the vehicle. In this case, the controller 160 may confirm the current location of the vehicle through a cellular network.

At step S67, the controller 160 confirms the locations of other users registered in the social network service corresponding to the second account. To this end, the controller 160 controls the communicator 110 and transmits a request signal to confirm the locations of the other users to the server 300. The server 300 which received the request signal confirms the list of the other users registered in the social network service of the second account, and confirms the locations of the users who registered their current locations in the social network service among the list to provide to the controller 160.

At step S69, the controller 160 extracts the list of the other users who are located within a certain distance based on the current location of the vehicle, and proceeds to step S41 to perform the above-mentioned steps.

On the other hand, at step S63, when the friend location confirming mode is not selected, at step S71, the controller 160 performs the function corresponding to the signal received from the input 130.

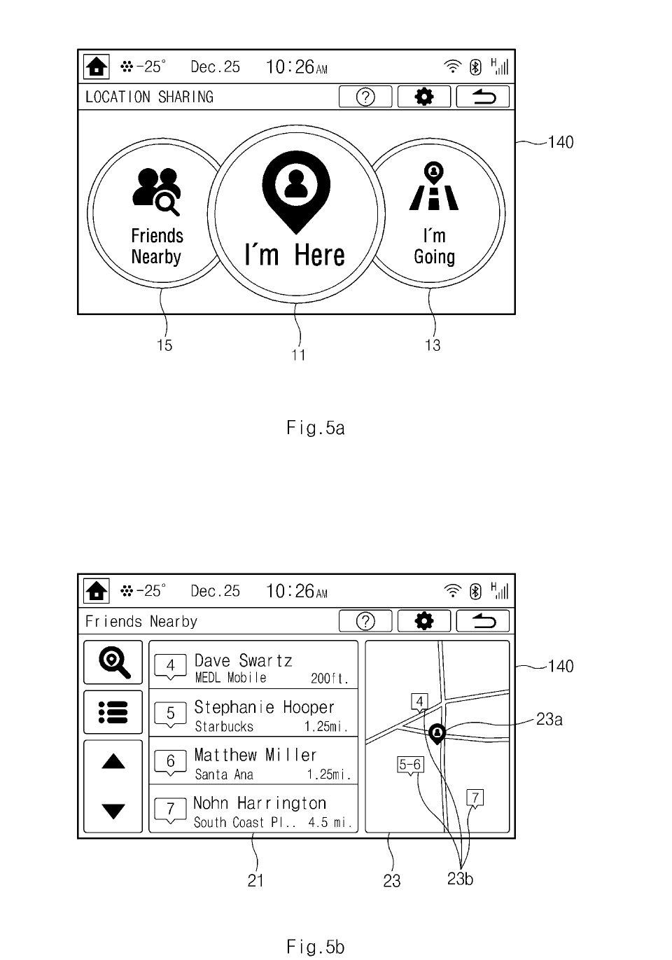

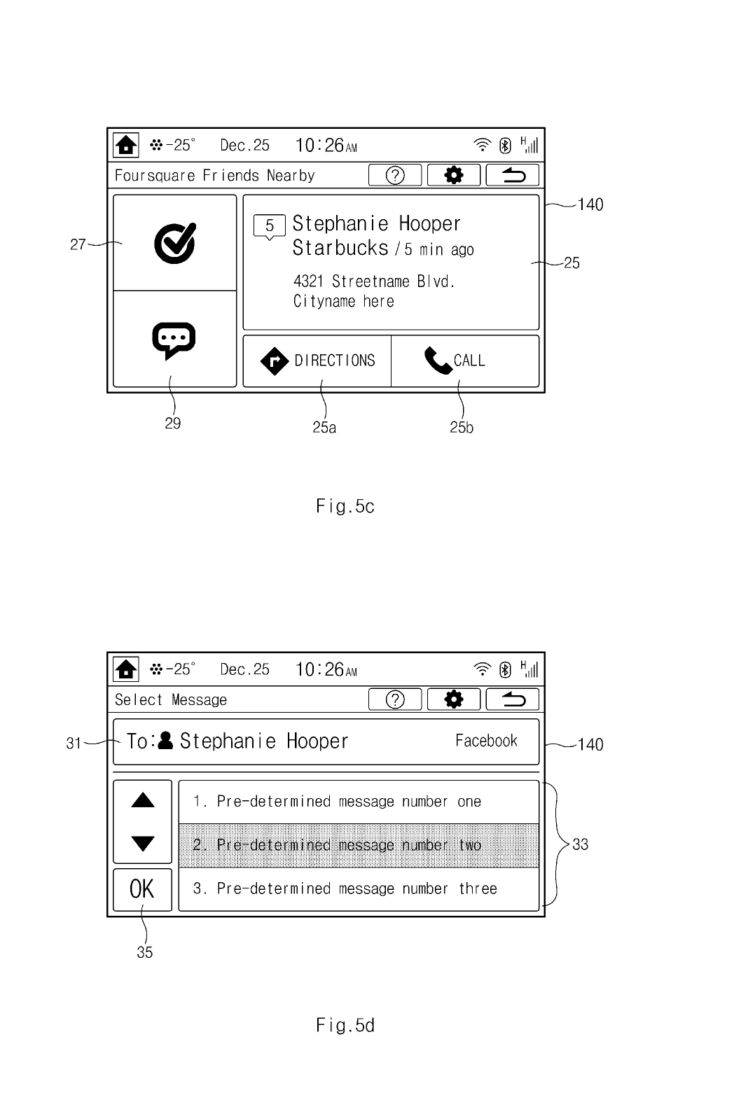

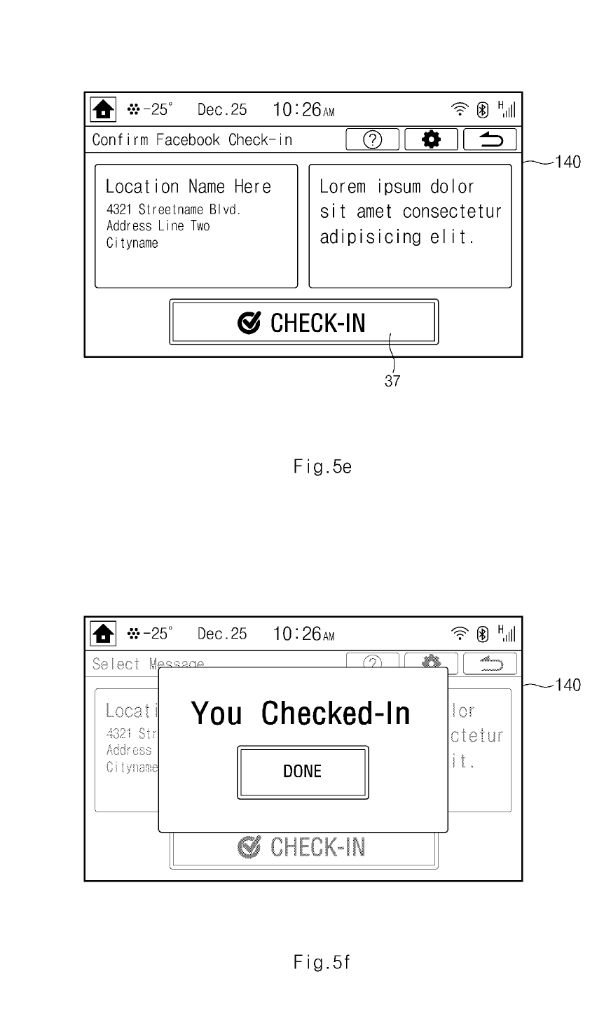

FIGS. 5A to 5F are exemplified diagrams illustrating a screen for sharing of location information according to an exemplary embodiment of the present disclosure.

Referring to FIG. 1 to FIG. 5, when the application is executed to enter into the location information sharing mode, the screen as illustrated in FIG. 5A is output on the output 140. Reference numeral 11 is a button for sharing the current location of the vehicle in which the user rides as described in step S37 of FIG. 4. Reference numeral 13 is a button for searching the destination as described in step S59 of FIG. 4 and reference numeral 15 is a button for confirming the friend location as described in step S63 of FIG. 4.

When the user selects the reference numeral 15 in FIG. 5A, the controller 160 displays a screen as illustrated in FIG. 5B on the output 140. The reference numeral 21 of FIG. 5B illustrates the list of the users who are located within a certain distance based on the current location (reference numeral 23a) of the vehicle among the users registered in the second account. The reference numeral 23 illustrates the current location 23a of the vehicle, and the current location of the users displayed in reference numeral 21 as reference numeral 23b.

When the user selects Stephanie Hooper in FIG. 5B, the controller 160 displays a screen as illustrated in FIG. 5C on the output 140. When the exact location of the Stephanie Hooper is output as illustrated in reference numeral 25 of FIG. 5C, and the user selects the reference numeral 25a, the controller 160 outputs a path from the current location of the user to the location of the Stephanie Hooper on the output unit 140. In addition, when the user selects the reference numeral 25a, the controller 160 performs the phone call to the business office corresponding to the location of the Stephanie Hooper. In addition, the reference numeral 27 of FIG. 5C is a button for uploading the current location of the vehicle to the social network service corresponding to the second account, and the reference numeral 29 of FIG. 5C is a button for sending the personal message to the specific user.

When the button corresponding to the reference numeral 29 is selected, the controller 160 outputs a screen as illustrated in FIG. 5D on the output 140 so that the user may send the message to the specific user. When the specific user is selected from the input 130, or it is previously set that the message is sent to the user selected in FIG. 5B, the controller 160 displays the user to whom the personal message is to be sent as illustrated in reference numeral 31. Reference numeral illustrates the list for the alarm message previously stored in the storage 150. Here, the user may select as the alarm message the personal message to be sent to the Stephanie Hooper in the reference numeral 33, or may directly write. When the input is generated in the reference numeral 35, the controller 160 outputs the screen for a final confirmation before sending the message to the Stephanie Hooper on the output 140, as illustrated in FIG. 5E. When reference numeral 37 of FIG. 5E is selected, the controller 160 shares the current location of the vehicle with the social network service corresponding to the second account, and sends the personal message to the Stephanie Hooper. As illustrated in FIG. 5F, the controller 160 outputs a message window indicating that the upload is completed on the output 140.

As set forth above, the present disclosure can manage the plurality of social network accounts using the user account corresponding to the VIN.

In addition, the present disclosure can confirm the current location information of those who are registered as friend in social network service in a vehicle and send messages to the friends.

Although exemplary embodiments of the present disclosure have been described in detail hereinabove, it should be clearly understood that many variations and modifications of the basic inventive concepts herein taught which may appear to those skilled in the present art will still fall within the spirit and scope of the present disclosure, as defined in the appended claims.

What is claimed is:

1. An apparatus for sharing of location information using a social network service, the apparatus comprising:
a communicator configured to communicate with a server for sharing of the location information;
a storage configured to map and store at least one first account to a vehicle unique number, and map and store at least one second account of social network service to the first account; and
a controller configured to confirm and display, when a login is completed using the first account, a point of interest (POI) and a current location of a vehicle through the server for sharing of the location information, and to share the current location and the location information through the social network service corresponding to the second account mapped to the first account.

2. The apparatus of claim 1, further comprising a sensor configured to confirm the current location of the vehicle.

3. The apparatus of claim 2, wherein when a destination is input from an external, the controller searches the POI based on the destination through the server, and shares a location and location information of the destination through the social network service.

4. The apparatus of claim 2, wherein when a signal to confirm locations of users registered in the second account is received from the external, the controller confirms a list and locations of the users who are located within a certain distance based on the current location.

5. The apparatus of claim 2, wherein the controller sends a personal message to another user by using at least one of accounts of other users registered in the second account, a portable terminal phone number and an e-mail of the other users stored in a phone book.

6. The apparatus of claim 1, wherein the vehicle unique number is a vehicle identification number (VIN).

7. The apparatus of claim 1, wherein the communicator receives the at least one first account mapped to the vehicle unique number stored in the server for sharing of the location information and the at least one second account of the social network service mapped to the first account.

8. A method for sharing of location information using a social network service, the method comprising steps of:
entering, by a controller, into a location information sharing mode based on an input from an external;
confirming, by the controller, that a login is completed for at least one first account mapped to a vehicle unique number;
confirming and displaying, by the controller, a point of interest (POI) and a current location of a vehicle; and
sharing, by the controller, the current location and the location information through a social network service corresponding to at least one second account mapped to the first account.

9. The method of claim 8, before the step of confirming that the login is completed, further comprising a step of entering into a location information sharing setting mode by the controller to map and store the first account and the second account.

10. The method of claim 8, before the step of confirming and displaying the POI and the current location of the vehicle, further comprising a step of entering into any one among a current location sharing mode of the vehicle, a destination searching mode, or a user location confirming mode based on the input from the external.

11. The method of claim 10, after the step of entering into the current location sharing mode of the vehicle, further comprising steps of:
confirming the current location of the vehicle in the current location sharing mode of the vehicle by the controller;
confirming the POI according to the current location;
displaying detailed information related to a selected POI when the POI is selected; and
connecting a call to the POI corresponding to the selected information when the displayed detailed information is selected.

12. The method of claim 10, after the step of entering into the destination searching mode of the vehicle, further comprising steps of:
searching a destination of the vehicle in the destination searching mode of the vehicle;
confirming the POI according to the destination;
displaying detailed information related to a selected POI when the POI is selected; and
connecting a call to the POI corresponding to the selected information when the displayed detailed information is selected.

13. The method of claim 10, after the step of entering into the user location confirming mode, further comprising:
confirming a current location of users registered in the second account; and
extracting and displaying a list of the users who are located within a certain distance based on the current location of the vehicle.

14. The method of claim 8, after the step of sharing the current location and information, further comprising a step of:
sending a personal message to another user using at least one of accounts of other users registered in the second account, a portable terminal phone number, and an e-mail of other users stored in a phone book.
